(19) United States
(12) Patent Application Publication
(10) Pub. No.: US 2025/0331686 A1
(43) Pub. Date: Oct. 30, 2025

(54) Solid Cooking Fat Dispenser

(71) Applicant: James R. Redfearn, Tulsa, OK (US)

(72) Inventor: James R. Redfearn, Tulsa, OK (US)

(21) Appl. No.: 19/036,606

(22) Filed: Jan. 24, 2025

Related U.S. Application Data
(60) Provisional application No. 63/638,017, filed on Apr. 24, 2024.

(51) Int. Cl. A47J 47/01; A47J 47/08

(52) U.S. Cl. CPC A47J 47/01; A47J 47/08

(57) ABSTRACT

A method and apparatus for storing and dispensing solid cooking fat for cooking is disclosed. In one embodiment, a dispenser for containing and dispensing solid cooking fat includes a main body having a nozzle, a base, a main body base, and a main body cavity. The solid cooking fat is disposed in the main body cavity. Rotation of the base in a direction rotates the nozzle and the main body base to move the solid cooking fat partially out of the main body and rotation of the base in an opposing direction retracts the solid cooking fat. The dispenser also includes a sleeve. The sleeve has a sleeve cavity. A portion of the main body is disposable in the sleeve cavity. The main body is removed from the sleeve when the solid cooking fat is to be dispensed.

### CROSS-REFERENCE TO RELATED APPLICATIONS

This U.S. Non-Provisional Application claims priority to U.S. Provisional Application Ser. No. 63/638,017 filed Apr. 24, 2024, the entire contents of which are incorporated herein by reference thereto.

### STATEMENT REGARDING FEDERALLY SPONSORED RESEARCH OR DEVELOPMENT

Not applicable.

### BACKGROUND OF THE INVENTION

### Field of the Invention

The invention relates to cooking utensils and more specifically to a device for dispensing solid cleansers, solid seasonings, and sold cooking fats such as butter, lard, tallow, coconut oil, shortening, and any other oil used in food preparation or cleanup that is normally solid at room temperature and applied to cooking surfaces such as a solid griddle.

### Background of the Invention

Cooktops such as skillets and griddles often have their cooking surfaces coated with a solid cooking fat such as butter. Such cooking surfaces are often coated for a variety of reasons such as to prevent the food being cooked from sticking to the cooktop, to add flavor to the food being prepared, to clean the cooking surface, and also to season the cooking surface. There are conventional methods and devices by which cooktops are coated.

One conventional method is to not use a tool or dispenser. Instead, the user directly holds a solid cooking fat such as a stick of butter (i.e., by hand) and spreads it across the cooking surface. Drawbacks to such conventional method include that an uncomfortable degree of heat may be exposed to the user's hand. Further drawbacks include that portions of the solid cooking fat may be wasted by being too short to spread or the user dropping the cooking fat due to the heat from the cooking surface. Additional drawbacks include that the user's hand may become greasy from handling the cooking fat, which may be untimely for meal preparation as the user may need to spend time washing the hand instead of preparing the meal.

A conventional device includes a block-shaped enclosure that houses stick butter. By squeezing a lever, the user slices off a fixed-sized piece of the butter stick. Such slice may then be spread on a surface (i.e., a slice of bread, cooking surface, and the like). Drawbacks include that the device may only use block-shaped solid cooking fats. Further drawbacks include that a separate utensil may be needed to distribute the solid cooking fat across the cooking surface.

An additional conventional device includes a block-shaped enclosure that houses stick butter. The device has a traveling base with an integrated threaded shaft that protrudes out of the rear of the device by rotation. Drawbacks include that the dispensed butter may be thinly shaved, which may cause the need for a separate utensil to spread the stick butter. Further drawbacks include that the protruding shaft may make the device unable to be disposed on its base, which may then take up valuable counter space. Drawbacks also include that the device may only use block-shaped solid cooking fats. A further drawback of this device may also be that there is no mechanism to maintain a secure hold on the solid cooking fat while being distributed on a heated surface (i.e., no nozzle).

A further conventional device includes a block-shaped enclosure that houses stick butter. The device may have a traveling base with an integrated shaft that protrudes through the cavity and therefore through the stick butter. Drawbacks to such device include difficulty with loading and unloading as solid cooking fats may need to be warmed in order to load or unload from the device as butter or other solid cooking fats become hard when cooled. Additional drawbacks include that the device may rely on the integrated shaft to hold the stick butter inside its cavity. Drawbacks also include that the device may only use block-shaped solid cooking fats.

Consequently, there is a need for an improved method and device for dispensing solid cooking fats.

### BRIEF SUMMARY OF SOME OF THE PREFERRED EMBODIMENTS

These and other needs in the art are addressed in one embodiment by a method and apparatus for storing and dispensing a solid (i.e., a solid cooking fat) for cooking. In one embodiment, a dispenser for containing and dispensing solid cooking fat includes a main body having a nozzle, a base, a main body base, and a main body cavity. The solid cooking fat is disposed in the main body cavity. Rotation of the base in a direction rotates the nozzle and the main body base to move the solid cooking fat partially out of the main body, and rotation of the base in an opposing direction retracts the solid cooking fat. The dispenser also includes a sleeve. The sleeve has a sleeve cavity. A portion of the main body is disposable in the sleeve cavity. The main body is removed from the sleeve when the solid cooking fat is to be dispensed.

The dispenser also includes a seal groove and a seal disposed within the seal groove. Moreover, the nozzle is removable. In addition, the solid cooking fat is cylindrical or rectangular. The base also includes grips.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a perspective view of an embodiment of a dispenser;

FIG. 2 illustrates a perspective view of an embodiment of a sleeve;

FIG. 3 illustrates a top view of an embodiment of a sleeve;

FIG. 4 illustrates a perspective view of an embodiment of a main body;

FIG. 5 illustrates a top view of an embodiment of a main body;

FIG. 6 illustrates a bottom view of an embodiment of a main body;

FIG. 7 illustrates a perspective view of an embodiment of a dispenser;

FIG. 8 illustrates a perspective view of an embodiment of a sleeve;

FIG. 9 illustrates a top view of an embodiment of a sleeve;

FIG. 10 illustrates a perspective view of an embodiment of a main body;

FIG. 11 illustrates a top view of an embodiment of a main body;

FIG. 12 illustrates a bottom view of an embodiment of a main body;

FIG. 13 illustrates an exploded perspective view of an embodiment of a dispenser;

FIG. 14 illustrates an exploded perspective view of an embodiment of a dispenser;

FIG. 15 illustrates a perspective view of an embodiment of a main body with a seal and a seal groove;

FIG. 16 illustrates a perspective view of an embodiment of a main body having a base with a base opening;

FIG. 17 illustrates a perspective view of a sleeve;

FIG. 18 illustrates a perspective view of an embodiment of a main body having a base with a base opening;

FIG. 19 illustrates a perspective view of a sleeve; and

FIG. 20 illustrates an embodiment of main body 10 with main body cover removed.

### DETAILED DESCRIPTION OF THE PREFERRED EMBODIMENTS

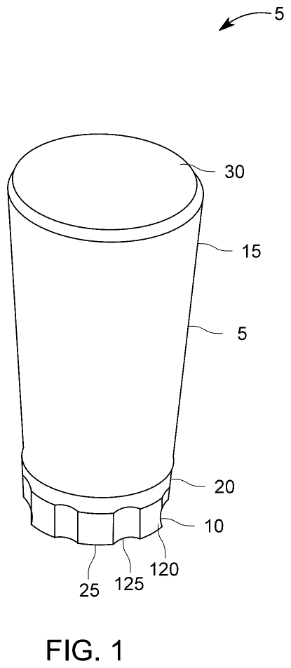

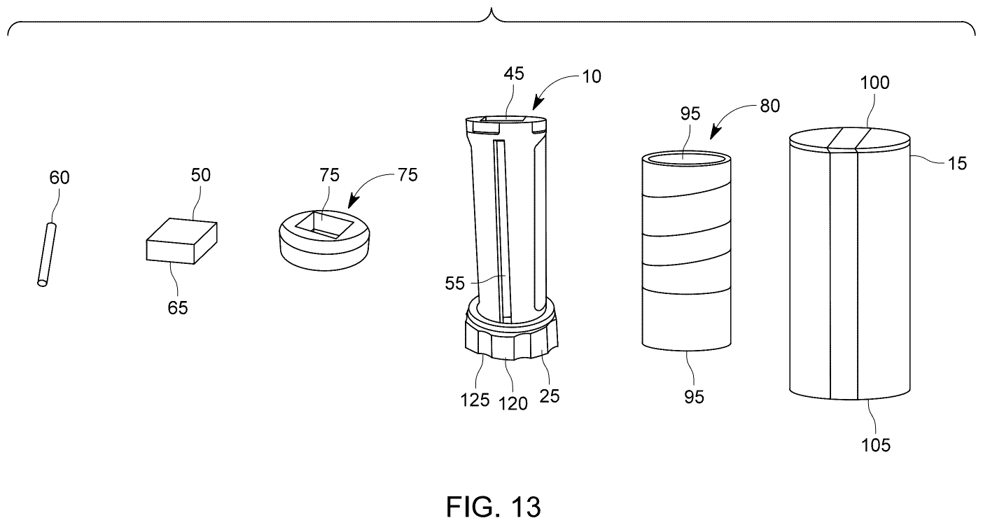

FIG. 1 illustrates a perspective view of an embodiment of dispenser 5. Dispenser 5 has main body 10 with base 25. Dispenser 5 also has sleeve 15. Sleeve 15 has sleeve top portion 30. In an embodiment as shown, sleeve 15 covers substantially all of main body 10 except for base 25. Sleeve 15 has sleeve bottom edge portion 20. Sleeve 15 also has sleeve closed end 100 and sleeve open end 105, as shown in FIGS. 13, 14, 17, and 19. Base 25 is rotatable. As shown, base 25 is disposed at a bottom portion of main body 10. In embodiments as shown, base 25 has raised grips 120. Without limitation, grips 120 facilitate a user to rotate base 25. In other embodiments (not illustrated), base 25 does not have grips 120. In an embodiment as shown, base 25 has base bottom portion 125. In embodiments, base bottom portion 125 is substantially flat. Without limitation, base bottom portion 125 is substantially flat to facilitate stable disposition of dispenser 5 on a surface such as a table. Further as shown, sleeve 15 has sleeve bottom edge portion 20 on an opposing longitudinal end of sleeve 15 from sleeve top portion 30. Sleeve 15 is slidable on and off of main body 10 with sleeve 15 covering substantially all of main body 10 except for base 25. When sleeve 15 is disposed on main body 10, sleeve bottom edge portion 20 is disposed proximate base 25.

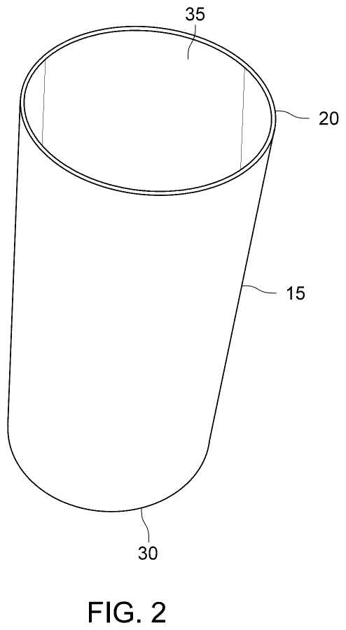

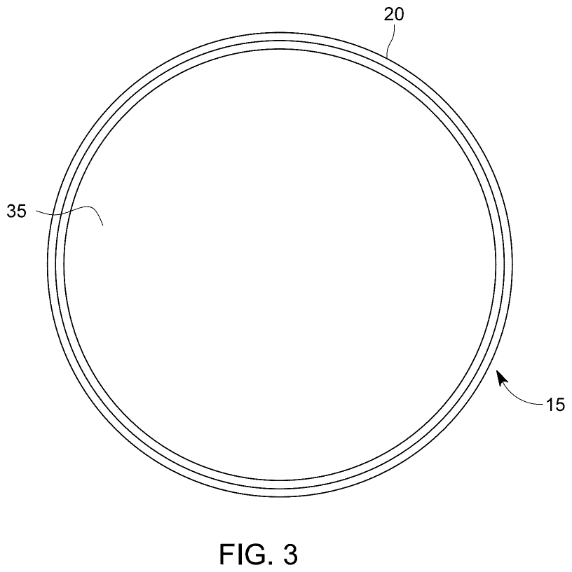

FIG. 2 illustrates a perspective view of sleeve 15. Sleeve 15 has sleeve cavity 35. Sleeve cavity 35 is configured to have main body 10 disposed within. In embodiments, the diameter of sleeve cavity 35 is greater than the diameter of main body cover 80 but about the same diameter or smaller than the diameter of base 25. FIG. 3 illustrates a top view of sleeve 15 showing sleeve cavity 35 and sleeve bottom edge portion 20. As shown in FIGS. 2 and 3, sleeve top portion 30 is closed, allowing sleeve 15 to substantially cover main body 10.

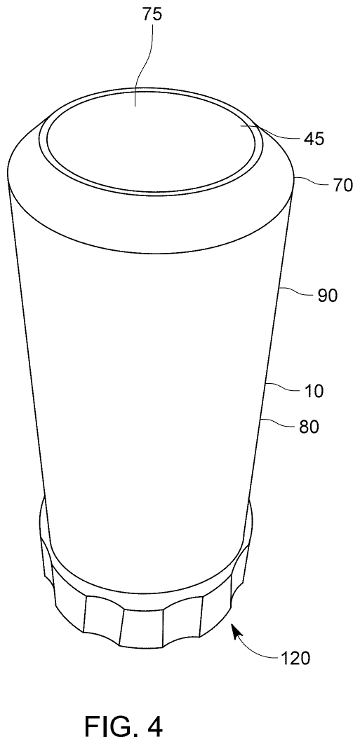

FIG. 4 illustrates a perspective view of main body 10. Main body 10 has main body cover 80, main body cavity 45, nozzle 70, and base 25. Base 25 is rotatable. In embodiments, nozzle 70 is rotated by base 25 and has nozzle opening 75, and rotates in the same direction as base 25. Nozzle 70 may be attached to main body 10 by any means suitable to allow nozzle 70 to be rotated upon rotation of base 25. Without limitation, such means may include pressure fit, tongue and groove, snap on fit, or any combinations thereof. In embodiments, such means include tongue and groove attachment. In an embodiment, nozzle 70 is removably attached to main body 10 to facilitate transportation and/or cleaning of nozzle 70 and main body 10. Nozzle 70 may also allow re-loading of solid cooking fats.

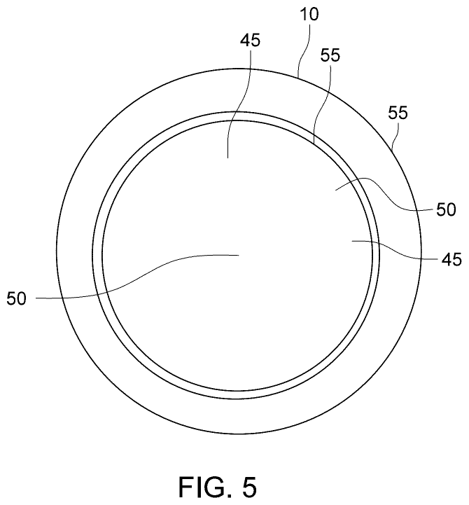

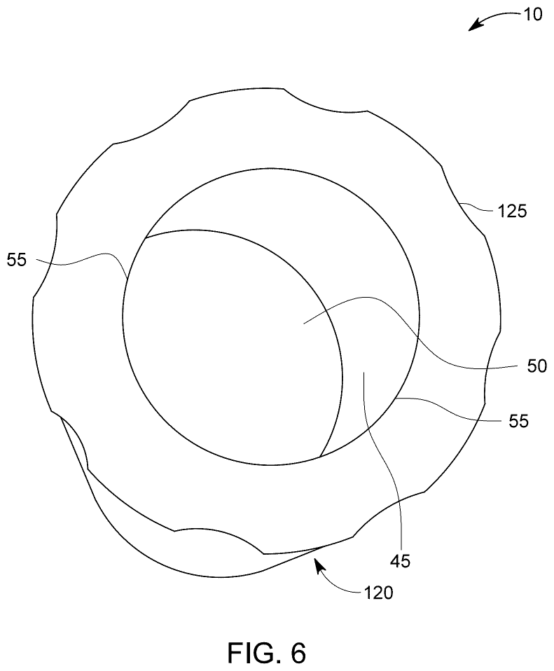

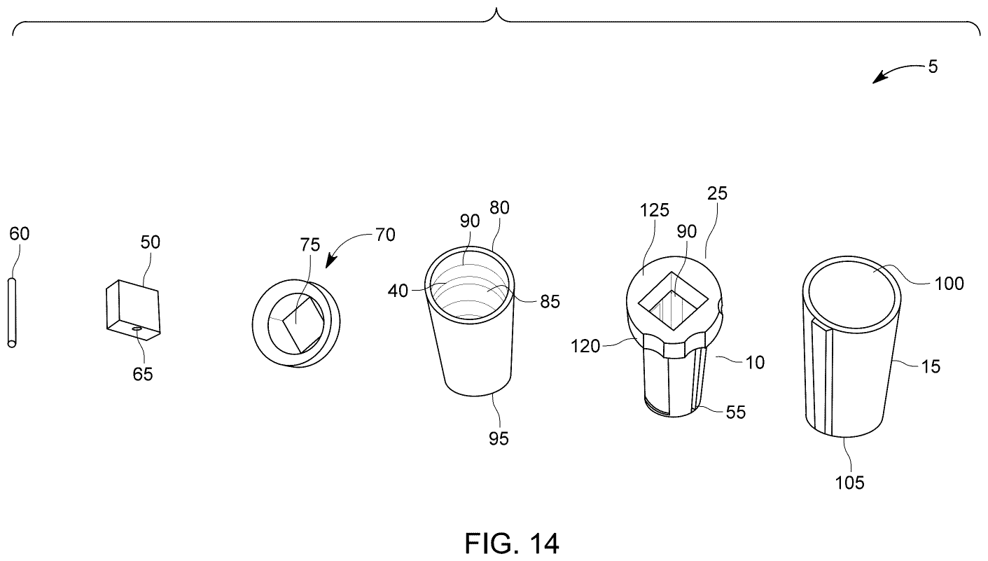

FIG. 5 illustrates a top view of main body 10, and FIG. 6 illustrates a bottom view of main body 10. Main body 10 has grooves 55. In embodiments, main body 10 has grooves 55 on opposing sides of main body 10. In embodiments, each groove 55 has a sufficient diameter and depth to allow opposing ends of supporting rod 60 (shown in FIGS. 13 and 14) to be disposed therein. Grooves 55 extend longitudinally substantially the length of main body 10. Main body 10 also has main body base 50, which is disposed in main body cavity 45 and is moveable longitudinally within main body cavity 45.

FIGS. 1-6 illustrate an embodiment in which main body 10 is disposed to receive the solid cooking fat having a cylindrical configuration.

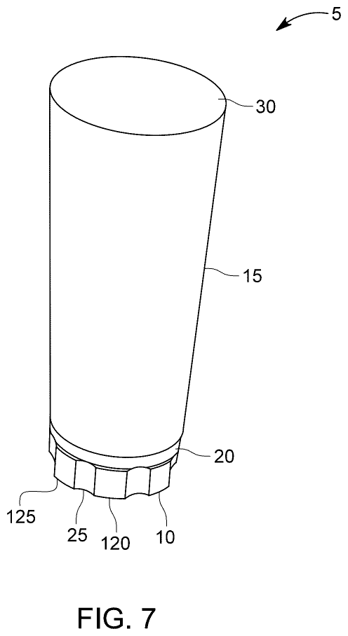

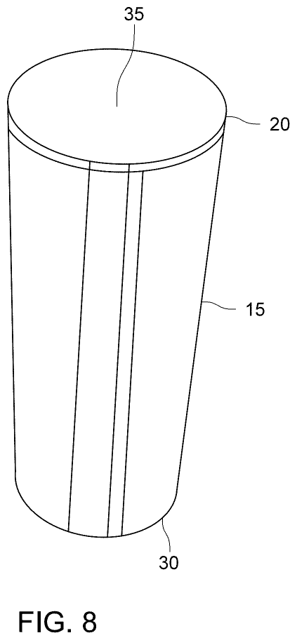

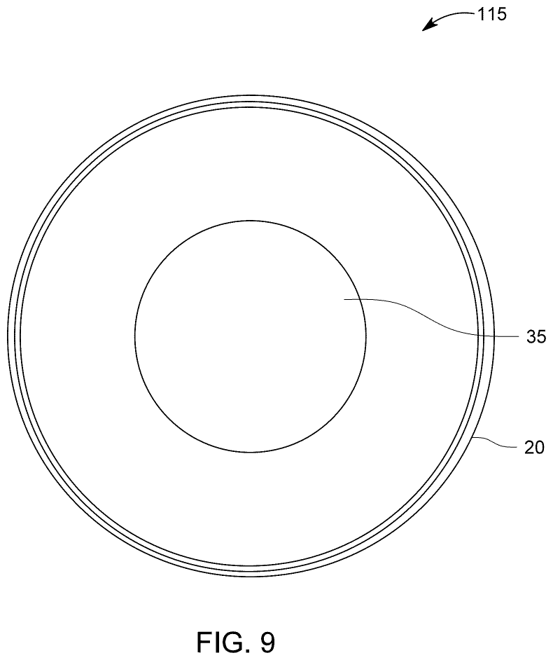

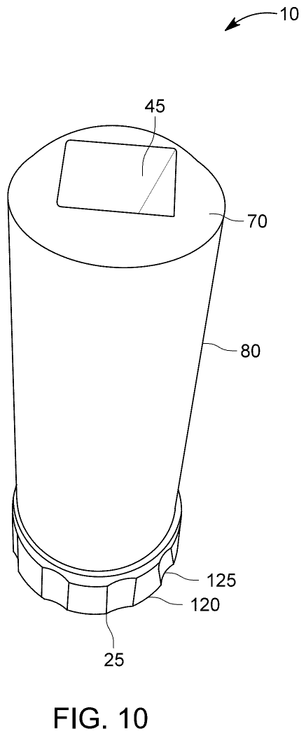

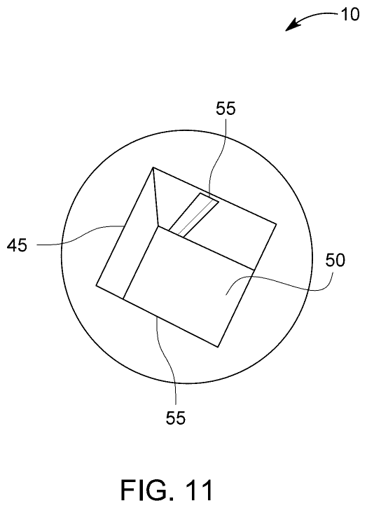

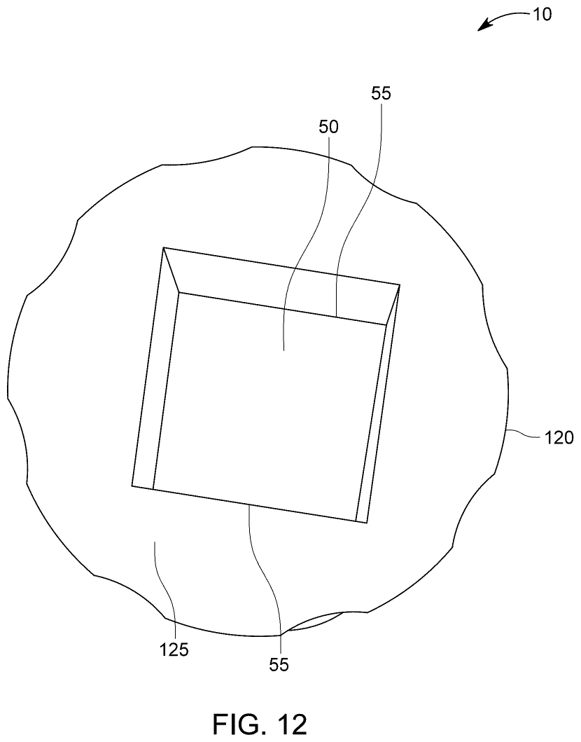

FIGS. 7-12 illustrate an embodiment in which main body 10 is disposed to receive the solid cooking fat having a rectangular (i.e., block shaped) configuration. FIG. 7 illustrates a perspective view of another embodiment of dispenser 5. FIG. 8 illustrates a perspective view of another embodiment of sleeve 15. FIG. 9 illustrates a top view of another embodiment of sleeve 15. FIG. 10 illustrates a perspective view of another embodiment of main body 10. In such embodiment, main body cavity 45 is disposed to receive the solid cooking fat having a block-shaped configuration (i.e., a full-length stick butter). FIG. 11 illustrates a top view of the embodiment of main body 10 shown in FIG. 10. Grooves 55 extend lengthwise on opposing sides in main body cavity 45 of main body 10. FIG. 12 illustrates a bottom view of main body 10, in which the moveable main body base 50 is illustrated having a configuration suitable for receiving the block-shaped solid cooking fat.

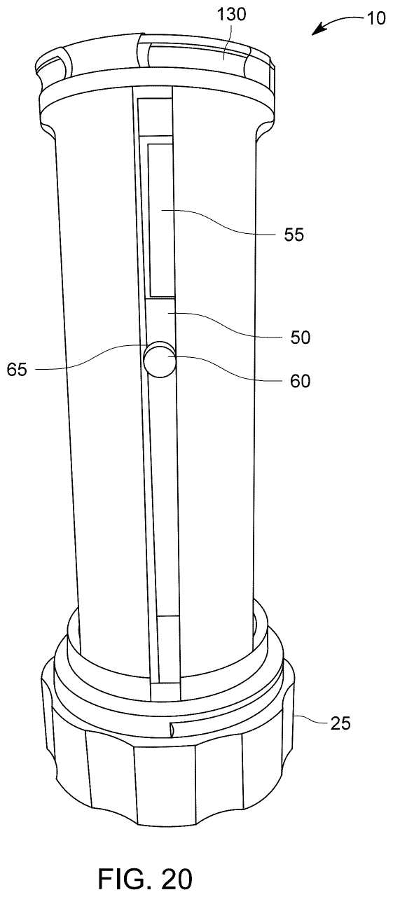

FIGS. 13 and 14 illustrates exploded views of dispenser 5 with dispenser 5 being disassembled. FIG. 20 illustrates an embodiment of main body 10 with main body cover 80 removed for illustration purposes only. As shown, dispenser 5 has supporting rod 60 and main body base 50. Main body base 50 has supporting rod channel 65. Supporting rod channel 65 extends through main body base 50 to the opposing side of main body base 50. Supporting rod channel 65 is of a sufficient diameter to allow supporting rod 60 to be disposed therein with a portion of supporting rod 60 extending outside of each opposing side of supporting rod channel 65. In embodiments, main body base 50 with supporting rod 60 disposed in supporting rod channel 65 is disposed in main body cavity 45. The opposing ends of supporting rod 60 extending out of opposing sides of supporting rod channel 65 are disposable in grooves 55, with each opposing end of supporting rod 60 that is extending out of supporting rod channel 65 disposed in opposing grooves 55. As further shown, main body cover 80 has main body cover opening 95 which is of a sufficient diameter to allow main body 10 to be disposed therein. Main body cover 80 also includes main body cover groove 85. Main body cover groove 85 is of a helical configuration disposed on inner surface 40 of main body cover 80 extending upwards longitudinally about inner surface 40. The helical configuration comprises two helix grooves disposed about 180 degrees opposite of each other. Outer edges 130 of main body 10 are disposed in main body cover groove 85. Outer edges 130 rotate in unison with main body 10 and base 25. Rod 60 is disposed in grooves 55, and, therefore, rod 60 and thus base 25 move up/down with rotation of base 25. Main body cover 80 has main body cover opening 95.

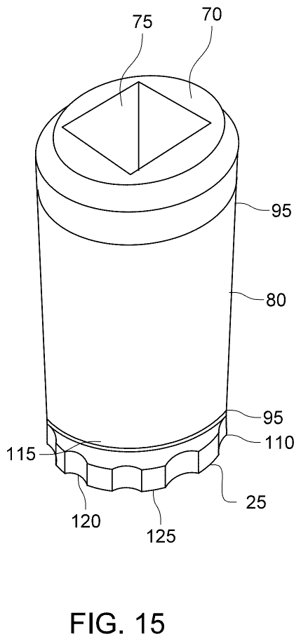

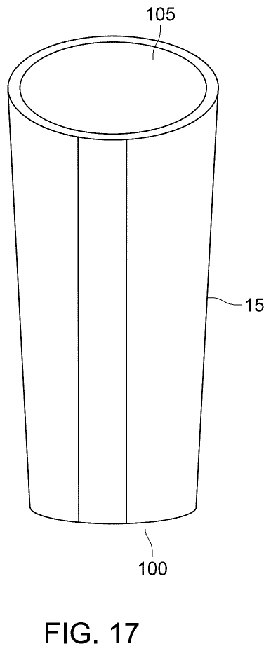

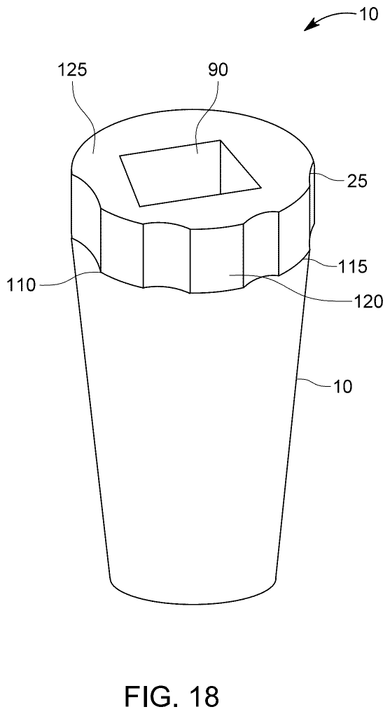

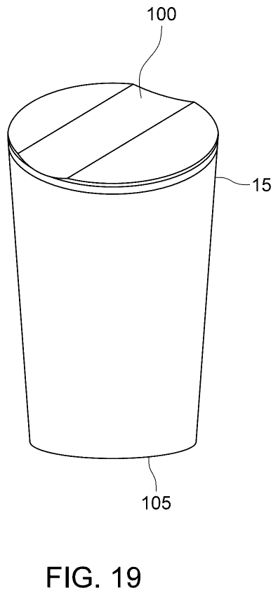

FIGS. 15 and 18 show views of embodiments of main body 10 without sleeve 15. FIGS. 17 and 19 show views of sleeve 15 not disposed on main body 10. It is to be understood that when sleeve 15 is disposed on main body 10, sleeve 15 may provide protection against outside elements contacting the solid cooking fat disposed in main body 10 as well as protecting nozzle opening 75 from outside elements.

As shown in embodiments of FIGS. 15 and 18, main body 10 has seal groove 115. Seal groove 115 is a groove disposed about the circumference of main body 10 proximate to base 25. Seal 110 is disposed within seal groove 115. Seal 110 may be any suitable configuration for providing a seal to main body 10. In an embodiment, seal 110 is an o-ring. Seal 110 may be disposed of any suitable material for providing a seal such as plastic, rubber, or any configuration thereof.

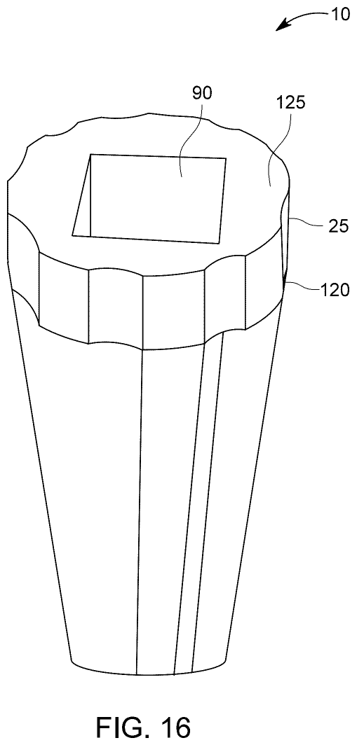

In embodiments of operation of dispenser 5 as shown in FIGS. 1-20, the solid cooking fat is inserted into dispenser 5 via main body cavity 45 and is disposed upon main body base 50. When base 25 is rotated in the direction to cause main body base 50 to move longitudinally upwards in main body cavity 45 in the longitudinal direction of nozzle 70, main body base 50 in turn moves the solid cooking fat upward through main body cavity 45 and out of nozzle opening 75 of the rotating nozzle 70 to be applied to a cooking surface such as a heated cooking surface. Base 25 may be rotated in the opposing direction (causing nozzle 70 to rotate in the opposing direction) to move main body base 50 in the opposing longitudinal direction of nozzle 70, causing the remaining solid cooking fat to be retracted back into nozzle 70 via nozzle opening 75 and retract back into main body cavity 45. Sleeve 15 may then be placed over main body 10 for storage, transportation, or the like.

In an embodiment of FIGS. 1-20, dispenser 5 may be generally shaped like a cylinder with varying dimensions, with one embodiment having a cylinder with an external diameter of about 2.0 inches to about 3.0 inches, alternatively about 2.375 inches and an overall height that may range between about 5.5 inches and about 6.75 inches. As shown, the center of dispenser 5 contains a cavity (i.e., main body cavity 45) that may be shaped also as a cylinder or as a rectangular block, either option running along the same axis as the dispenser 5 itself.

In further embodiments as shown in FIGS. 1-20, main body cavity 45 provides the location where the solid cooking fat is disposed before, during, and after use. Main body cavity 45 contains main body base 50 that is free to travel longitudinally up and down the length of main body cavity 45. Main body base 50 may be connected to main body 10 disposed in main body cover 80 of dispenser 5. Main body 10 may have two grooves (i.e., grooves 55) configured in it its surface. By rotating main body 10 in main body cover 80, the base (i.e., main body base 50) travels either up or down the length of the cavity (i.e., main body cavity 45) and therefore also the dispenser 5, depending on the direction of rotation.

In further embodiments as shown in FIGS. 1-20, the top of dispenser 5 may contain a removable nozzle 70 that may be removed to load and unload solid cooking fats into the dispenser cavity (i.e., main body cavity 45). Nozzle 70 may have a geometry on its base that matches that of the dispenser cavity (i.e., main body cavity 45). Such geometry may taper in towards the top of nozzle 70 whereby the solid cooking fat is squeezed around its circumference by nozzle 70. As main body cover 80 is rotated, the solid cooking fat may be pushed by base 25 through nozzle 70 creating the dispensing action. Nozzle 70 may provide a constant hold on the solid cooking fat inside dispenser 5 such that it does not prematurely exit dispenser 5. Nozzle 70 has the added benefit of deflecting heat whereby shielding the solid cooking fat inside from the heat of the cooktop. This may prevent the solid cooking fat from melting, prematurely dispensing, wasting excess melted fat, or allowing potentially contaminated melted fat back into main body cavity 45 near the unused solid cooking fat and hence may prolong the fat's useable life.

Illustrated in an embodiment of FIGS. 1-20, a removable cap (not illustrated) may cover nozzle 70 to a position just above the base of nozzle 70 proximate main body cover 80. The cap may protect the interior contents from external factors such as heat or any type of polluting factors. Dispenser 5 may be made of any suitable material. In embodiments, dispenser 5 comprises solid food-safe materials such as plastic, stainless steel, metal alloys, wood, glass, ceramics, or any combinations thereof.

In embodiments, dispenser 5 may be used with any cooking surface such as griddles, frying pans, stove tops, grills, and the like. Dispenser 5 may be used with any suitable solid cooking fats, solid cleaning products, solid seasoning products, or any combinations thereof. The solid cooking fats include butter, lard, shortening, tallow, coconut oil, palm oil, palm kernel oil, or any combination thereof. A purpose of dispenser 5 includes holding the solid cooking fat on the cooking surface when coating the cooking surface with the solid cooking fat (i.e., dispensing) while simultaneously providing a place to grip dispenser 5 that may be consistently far enough from the cooking surface such that the user's hand does not experience extreme or uncomfortable heat while dispensing. Other purposes of dispenser 5 are to improve the overall cooking experience by ensuring clean hands throughout the dispensing process, reducing the number of utensils and dishes used for dispensing, and dispensing quickly and precisely while maintaining a place to hold and store unused product.

Embodiments also include dispenser 5 having a traveling base motion mechanism. The motion of base 25 is caused by the interaction of base 25 with main body cover 80 and main body 10, which may leave the internal cavity (i.e., main body cavity 45) void of any parts that may need to penetrate the solid cooking fat. This feature may make loading and unloading solid cooking fat refills quicker, cleaner, and easier than other designs that may need refills skewered by a shaft such as a threaded shaft when inserting.

In embodiments, dispenser 5 has an open bottom (i.e., base opening 90). The open bottom (base opening 90) may allow the user to see or feel the amount of remaining solid cooking fat in dispenser 5, which may add convenience to the cooking process. In embodiments, base opening 90 may be covered. Base opening 90 may be covered by any suitable means such as by a cap (not illustrated).

The design of dispenser 5 may result in a dispenser 5 that encloses the solid cooking fat with relatively thick walls, which may provide an insulation that may protect the solid cooking fat from the heat of the cooktop and also may provide protection from the ambient temperatures to which the solid cooking fat may be exposed while using in an outdoor environment. Such design may prevent waste and degradation of the solid cooking fat in between uses, when used in an outdoor environment having high temperatures.

In embodiments, dispenser 5 may be used with solid cooking fats having any configurations. In embodiments, dispenser 5 may be used with solid cooking fats with cylindrical shape, rectangular (i.e., block shape such as full-length stick butter), and the like.

In embodiments, dispenser 5 does not slice or dispense a pre-determined amount of solid cooking fats. In an embodiment, dispenser 5 extrudes a user-defined amount of solid cooking fat in a desired amount to coat the intended cooking surface (i.e., heated cooking surface), and provides the ability to simultaneously spread the solid cooking fat on the cooking surface without using an additional utensil. Embodiments also include dispenser 5 having an open cavity design that may not need the solid fat to be skewered.

Although the present invention and its advantages have been described in detail, it should be understood that various changes, substitutions and alterations may be made herein without departing from the spirit and scope of the invention as defined by the appended claims.

What is claimed is:

1. A dispenser for containing and dispensing a solid, comprising:
a main body comprising a nozzle, a base, a main body base, and a main body cavity, wherein the solid is disposed in the main body cavity, and wherein rotation of the base in a direction rotates the nozzle and the main body base to move the solid partially out of the main body and rotation of the base in an opposing direction retracts the solid; and
a sleeve, wherein the sleeve comprises a sleeve cavity, and wherein a portion of the main body is disposable in the sleeve cavity, and further wherein the main body is removed from the sleeve when the solid is to be dispensed.

2. The dispenser of claim 1, further comprising a seal groove and a seal disposed within the seal groove.

3. The dispenser of claim 1, wherein the nozzle is removable.

4. The dispenser of claim 1, wherein the solid is cylindrical or rectangular.

5. The dispenser of claim 1, wherein the base comprises grips.

6. The dispenser of claim 1, wherein the solid comprises a solid cooking fat.
